(19) United States
(12) Patent Application Publication
(10) Pub. No.: US 2023/0026596 A1
(43) Pub. Date: Jan. 26, 2023

(54) SOLID-STATE BATTERY CATHODES AND METHODS THEREOF

(71) Applicant: University of Washington, Seattle, WA (US)

(72) Inventors: Jihui Yang, Seattle, WA (US); Jun Liu, Seattle, WA (US); Xiang Han, Seattle, WA (US)

(73) Assignee: University of Washington, Seattle, WA (US)

(21) Appl. No.: 17/786,305

(22) PCT Filed: Dec. 16, 2020
(86) PCT No.: PCT/US2020/065340

§ 371 Date: Jun. 16, 2022

Related U.S. Application Data
(60) Provisional application No. 62/949,952, filed on Dec. 18, 2019.

(51) Int. Cl. H01M 4/525; H01M 10/0562; H01M 10/0525; H01M 4/505; H01M 4/38; H01M 4/04; H01M 10/0565

(52) U.S. Cl. CPC H01M 4/525; H01M 10/0562; H01M 10/0525; H01M 4/505; H01M 4/382; H01M 4/0471; H01M 10/0565; H01M 2004/028

(57) ABSTRACT

The present disclosure describes a lithium solid state battery, including a cathode that includes an active material such as lithium, and an additive having a lower melting point than the active material. The additive can provide a composite cathode where a cathode-electrolyte interphase has high electronic and ionic conductivity, good mechanical deformability, and high oxidation potential.

### CROSS-REFERENCE TO RELATED APPLICATION

This application claims the benefit of U.S. Patent Application No. 62/949,952, filed Dec. 18, 2019, the disclosure of which is hereby incorporated by reference in its entirety.

### STATEMENT OF GOVERNMENT LICENSE RIGHTS

This invention was made with government support under Grant No. DE-EE0007763, awarded by the U.S. Department of Energy. The government has certain rights in the invention.

### BACKGROUND

High-performance solid-state batteries (SSBs) with non-flammable, inorganic solid-state electrolytes (SSEs) have been considered as a prospective candidate for safe lithium-ion batteries. Sulfide-based Li₁₀GeP₂S₁₂ (LGPS), Garnet-type Li₇La₃Zr₂O₁₂ (LLZO), and NASICON-type Li_{1.3}Al_{0.3}Ti_{1.3}(PO₄)₃ (LATP) are the most promising SSEs due to their high ionic conductivity (10⁻⁴-10⁻² S cm⁻¹). To achieve high-energy density in SSBs, it is possible to either increase the mass loading or extend the voltage range of cathode materials. Without wishing to be bound by theory, assuming an SSE thickness of 100 μm, the cathode areal capacity loadings should be above 7.3, 4.8, and 3.2 mAh cm⁻² for LLZO, LATP, and LGPS to reach the gravimetric energy density of liquid cells. Progress has been made to achieve high-energy SSBs using sulfide-based electrolytes owing to their mechanical resilience and superior interfacial compatibility with the cathode active materials. The reported sulfide-based SSBs have capacity loading in the range of 0.75-1.7 mAh cm⁻². Their air sensitivity (which generates H₂S toxic gas when exposed to moisture) and narrow electrochemical window, however, largely hinder the practical applications. For air-stable LATP- and LLZO-based SSEs, nonetheless, due to the intrinsically large interfacial resistance, the composite cathodes typically deliver a capacity <0.5 mAh cm⁻², far below the desired values.

Without wishing to be bound by theory, it is believed that to make a high-loading cathode work in a wide voltage range, the interphases between the cathode materials and SSEs should have the following characteristics i) high electronic and ionic conductivity to reduce the voltage polarization; ii) good mechanical deformability to enable superior mechanical stability as well as intimate interfacial contacts; and iii) high oxidation potential (>4 V) to minimize the continuous interphase growth. Among oxide electrolytes, LATP shows a high intrinsic oxidation voltage (4.3 V as compared to 3.5 V for LLZO vs. Li/Li⁺), and a lower density (3 g cm⁻³ vs. 5 g cm⁻³ for LLZO), which are advantageous for achieving high energy density in SSBs.

Taking the LATP/LiCoO₂ (LCO) cathode as an example, to build mixed conductive interphases and to achieve high density, high temperature sintering (>900° C.) is normally needed. However, at high temperatures, severe interdiffusion and chemical reactions between LATP and LCO can cause hard-to-control thick interphases that typically have low conductivity.

There is a need for a lower temperature sintering (<700° C.) technique for making high loading cathodes. There is also a need for interphases that are self-limiting, electronically and ionically conductive, and intimately contacting the solid state electrolyte(s) and the cathode active material in the SSB. The present disclosure seeks to fulfill these needs and provides further related advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present disclosure features a lithium solid state battery, including a cathode including an active material comprising lithium; and an additive having a lower melting point than the active material.

In another aspect, the present disclosure features a method of making a cathode for a lithium solid state battery, including mixing a lithium-containing cathode active material, an optional solid electrolyte, and an additive having a lower melting point than the active material to provide a mixture; and sintering the mixture to provide the cathode.

In yet another aspect, the present disclosure features a method of making a lithium solid state battery, including providing a cathode of the present disclosure, and assembling the cathode with a gel electrolyte and a lithium anode to provide the lithium solid state battery.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1A is a diagram showing a dihedral angle ψ for liquid at a grain boundary.

FIG. 1B is an illustration of an embodiment of a co-sintered composite cathode and SSE with in situ-formed interphases. The novel composite cathode/SSE configuration can provide high-loading SSBs with low interfacial resistance.

FIG. 1C is a graph showing the ionic conductivities of LATP pellets, LABTP pellets, and LABTP/LCO composite cathodes sintered at different temperatures.

FIG. 1D is a graph comparing the areal capacity of embodiments of SSBs of the present disclosure (LABTP-based SSBs) with previously reported LLZO-, LATP-, and LGPS-based SSBs. The inset is a photograph of an embodiment of a pellet of the present disclosure (co-sintered LABTP/LCO-LABTP heterogeneous pellet).

FIG. 2A shows x-ray diffraction (XRD) patterns of embodiments of SSE (synthesized LATP, LABTP (1 wt. % B₂O₃), and LABTP (2 wt. % B₂O₃) powders).

FIG. 2B is a scanning electron microscopy (SEM) image of the fractured surfaces of an embodiment of an SSE (LATP (900° C.)).

FIG. 2C is a scanning electron microscopy (SEM) images of the fractured surfaces of an embodiment of an SSE of the present disclosure (LABTP (750° C.)).

FIG. 2D is a graph comparing the impedance spectra of embodiments of cathode active material pellets at 25° C.

FIG. 2E shows the Arrhenius plots of ionic conductivities of embodiments of cathode active material pellets.

FIG. 2F shows cyclic voltammograms of an embodiment of a solid state electrode (LATP/C electrode) between 2.0 V and 4.5 V with a scanning rate of 0.1 mV s⁻¹.

FIG. 3A is a plot of DFT calculations of the reaction energy versus composition of a pseudo-binary cathode (LATP/LCO) system.

FIG. 3B shows the XRD patterns of embodiments of SSE-cathode active material composites (LATP/LCO and LABTP/LCO) with different ratios of active materials sintered at various temperatures.

FIG. 3C is a SEM image of an embodiment of a heterogenous cathode pellet (LABTP/LCO-LABTP heterogeneous pellet, showing a thick composite cathode (˜0.26 mm) on dense LABTP).

FIG. 3D is a high-magnification SEM image of an embodiment of interphases between embodiments of solid state electrolyte and cathode active material (LABTP and LCO).

FIG. 3E is a plot of EDS line scan across embodiments of interphases, inset shows a dark field transmission electron microscopy (TEM) image.

FIG. 3F is a SEM image of an embodiment of close interfaces between an embodiment of the cathode layer and dense SSE (LABTP) layer.

FIG. 3G is an image of EDS elemental mappings of titanium (Ti).

FIG. 3H is an image of EDS elemental mappings of phosphorus (P).

FIG. 3I is an image of EDS elemental mappings of cobalt (Co).

FIG. 4A is a two-dimensional ⁷Li-⁷Li exchange spectra of an embodiment of sintered SSE-cathode active material (LABTP/LCO), inset is a ⁷Li cross sectional MAS-NMR spectra along the dashed line.

FIG. 4B shows the Nyquist plots of an embodiment of a composite cathode (LABTP/LCO-3:7 (640° C.) composite cathode).

FIG. 4C is a graph of the temperature-dependent ionic conductivity of embodiments of cathodes (LATP/LCO and LABTP/LCO cathodes).

FIG. 4D is a graph of the temperature-dependent electronic conductivity of embodiments of cathodes (LATP/LCO and LABTP/LCO cathodes).

FIG. 5A is a graph of the cycling stability of embodiments of cathodes (LABTP/LCO-1:1 sintered at different temperatures (580° C., 640° C., and 700° C.)) in semi-solid batteries at 30° C. The active material (LCO) loading was ˜33 mg cm⁻² and the charge and discharge rates were set to 0.05 C (1 C=140 mAh g⁻¹, based on LCO loading) in a voltage range of 3.0-4.2 V. Inset is the schematic configuration of the semi-solid battery.

FIG. 5B is a graph of cycling performance of an embodiment of cathodes (LABTP/LCO-3:7 (640° C.) with areal loadings of 44 mg cm⁻² and 73 mg cm⁻² cycled between 3.0-4.4 V). The charge and discharge rates were set to 0.05 C (1 C=140 mAh g⁻¹, based on the LCO loading).

FIG. 5C is a graph of the cycling performance of an embodiment of an SSB with an areal capacity of ˜2 mAh cm⁻² at 55° C. Inset picture shows an SSB containing the LABTP/LCO-LABTP heterogenous pellet, PVDF-HFP gel electrolyte, and Li metal anodes.

FIG. 6A is a cross-sectional TEM image of an embodiment of a cathode of the present disclosure (NMC622/B₂O₃ (2 wt. %) cathode), showing fine NMC primary particles embedded in Li₃BO₃ solid electrolytes.

FIG. 6B is a high resolution TEM image showing interphases between an embodiment of a cathode active material and an embodiment of an SSE (NMC622 and Li₃BO₃), showing its condensed and uniform morphology.

FIG. 6C is a graph from electron energy loss spectroscopic (EELS) measurement of the interphases between an embodiment of a cathode active material and an embodiment of an SSE (NMC and Li₃BO₃).

FIG. 6D is a graph of the cycling performance of an embodiment of cathodes the present disclosure (NMC622/B₂O₃ (2 wt. %) cathodes with NMC622 mass loading of 66 mg cm⁻² in an SSB).

FIG. 6E is a graph of the calculated energy densities of embodiments of batteries of the present disclosure (LABTP/LCO and NMC622 (2 wt. % B₂O₃) cathodes assembled in pouch cells). A high energy density of 400 Wh kg⁻¹ can be achieved using the NMC622/B₂O₃ (2 wt. %) cathode with a LATP SSE<40 μm.

### DETAILED DESCRIPTION

Replacing flammable liquid electrolyte by ceramic solid-state electrolyte can offer increased energy density and improved safety of lithium-ion batteries. Challenges toward high-performance solid-state batteries include, for example, the large impedance posed by the electrode-electrolyte interphases and high loading composite cathode design. The ideal cathode-electrolyte interphases should have high electronic and ionic conductivity, good mechanical deformability, and high oxidation potential.

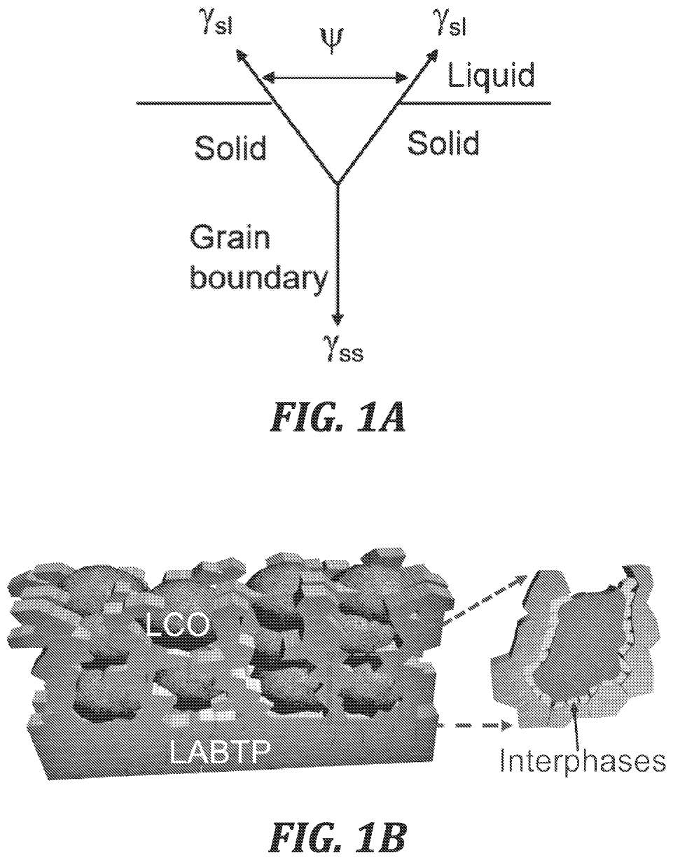

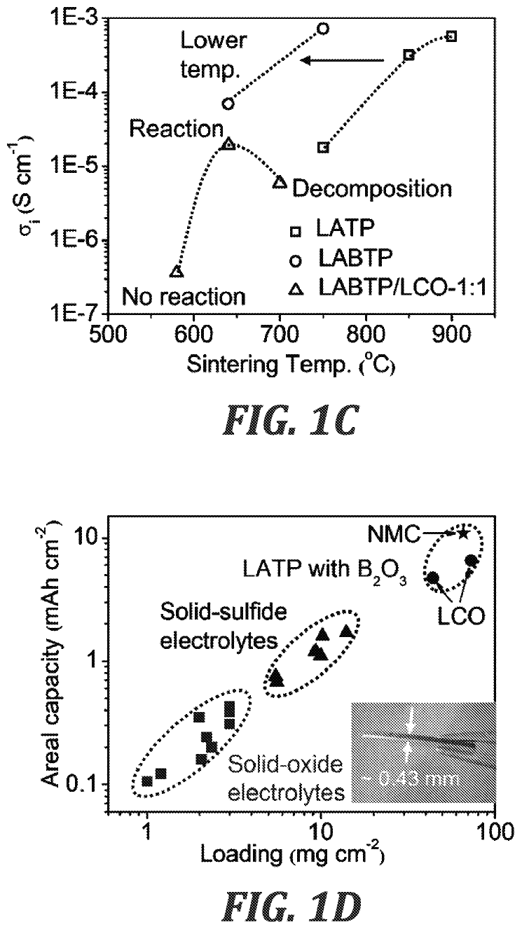

Without wishing to be bound by theory, it is believed that liquid-phase sintering with low-melting-point additives can be used in ceramic sintering to enhance densification rates, to achieve accelerated grain growth, and/or to produce specific grain boundary properties at relatively lower temperatures. This technique can allow the fabrication of much higher density thick cathodes (on the order of centimeter(s) in thickness). To achieve high energy density in SSBs, depending on the thickness of the matching Li metal anode, the cathode thickness can preferentially be in the range of 0.1 mm to 0.2 mm. Liquid-phase sintering with low-melting-point additives can allow the rational design of the composition of the interphases and hence the desired interphase properties. FIG. 1A shows the dihedral angle (ψ) between the solid-liquid interfaces with the solid-solid specific energy γₛₛ and solid-liquid specific energy γₛₗ. The wetting of grain boundaries occurs when 2 γₛₗ<γₛₛ. Thus, without wishing to be bound by theory, it is believed that additives with lower γₛₗ can promote wetting of the grains during sintering.

The present disclosure describes a lithium solid state battery, including a cathode that includes an active material such as lithium, and an additive having a lower melting point than the active material. As used herein, the melting point is the temperature at which a material melts at atmospheric pressure, which can be measured using differential scanning calorimetry. The additive can provide a composite cathode where a cathode-electrolyte interphase has high electronic and ionic conductivity, good mechanical deformability, and high oxidation potential.

### Definitions

As used herein, the term “battery” is used interchangeably with “cell.”

As used herein, the term “dendrites” refers to the needle-like dendritic crystals that form on the surface of a lithium electrode during charging/discharging of a lithium battery.

As used herein, the term “sintering” refers to a process of compacting and forming a solid mass of material by heat and/or pressure, without melting the material. Sintering is used to achieve a high density of a given material.

As used herein, the term “sintering temperature” refers to a temperature at which the sintering process takes place.

As used herein, with respect to measurements, “about” means +/−5%.

As used herein, a recited range includes the end points, such that from 0.5 mole percent to 99.5 mole percent includes both 0.5 mole percent and 99.5 mole percent.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

Aspects of the disclosure can be modified, if necessary, to employ the systems, functions, and concepts of the above references and application to provide yet further embodiments of the disclosure. These and other changes can be made to the disclosure in light of the detailed description.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

Example devices, methods, and systems are described herein. It should be understood the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

### Lithium Solid State Battery

As discussed above, the present disclosure features a lithium solid state battery, including a cathode that includes an active material such as lithium, and an additive having a lower melting point than the active material.

The active material of the lithium solid state battery can include a lithium-containing layered oxide, a lithium-containing polyanion, a lithium-containing spinel, or any combination thereof. For example, the active material can include a lithium-containing layered oxide (e.g., an NMC (LiNi_{1-x-y}MnₓCo_{y}O₂LiCoO₂), and/or LiNi_{0.6}Mn_{0.2}Co_{0.2}O₂ (NMC622)). The active material of the lithium solid state battery of the present disclosure can be in the form of particles having a dimension of from 10 nm to 90 μm (e.g., from 10 nm to 10 μm, from 100 nm to 90 μm, from 100 nm to 70 μm, from 100 nm to 50 μm, from 100 nm to 30 μm, from 300 nm to 70 μm, from 300 nm to 50 μm, from 300 nm to 30 μm, from 500 nm to 70 μm, from 500 nm to 50 μm, from 500 nm to 30 μm, from 10 nm to 1 μm, from 10 nm to 800 nm, or from 10 nm to 500 nm). In some embodiments, the active material particles have a dimension of from 10 nm to 500 nm.

The lithium solid state battery can further include a solid electrolyte, such as Li_{1.3}Al_{0.3}Ti_{1.7}(PO₄)₃ (LATP). Without wishing to be bound by theory, it is believed that the choice of solid electrolyte depends on the reaction products between the solid electrolyte and the additive. It is believed that the reaction products or the interphases should have the following characteristics: high electronic and ionic conductivity to reduce the voltage polarization; good mechanical deformability to enable superior mechanical stability as well as intimate interfacial contacts; and/or high oxidation potential (>4 V) to minimize the continuous interphase growth.

The additive and the active material together can form a eutectic mixture. In some embodiments, the additive, the active material, and the solid electrolyte together form a eutectic mixture. As used herein, a eutectic mixture refers to a homogeneous mixture of substances that melts or solidifies at a single temperature that is lower than the melting point of any of the constituents.

The additive has a lower melting point than the active material can include an additive such as liquid phase B₂O₃, which exhibits extremely low interfacial energy (0.08 J m⁻²) comparable to water (0.072 J m²) and having a melting point of 450° C. As an example, B₂O₃ is shown below to be effective as an additive for sintering LATP and LCO. As used herein, “low melting point additive” refers to an additive having a lower melting point than the active cathode material and the solid electrolyte.

The additive can include B₂O₃, Bi₂O₃, and/or any other low melting temperature additive(s) such as talc (Mg₃Si₄O₁₀(OH)₂), CaO—SiO₂, LiF, TiO₂, MgO, and/or Y₂O₃—Al₂O₃, which, in their molten state, have small but non-zero (e.g., a fraction of a percent to 1, 2, 3, 4, or 5 percent) solubilities of the cathode active materials; low liquid-to-solid surface energy (e.g., less than 0.1 J/m²) against the cathode active materials; and do not readily react (e.g., do not react) with the cathode active materials at room temperature. As used herein, “room temperature” refers to a temperature of 20° C. to 25° C., at 1 atmosphere.

The low melting point additive can be present in the cathode in an amount of 0.5% to 4% by weight (e.g., 0.5% to 3% by weight, 0.5% to 2% by weight, 1% to 4% by weight, 1% to 3% by weight, or 1% to 2% by weight), relative to the mass of the total cathode. The additive can lower a sintering temperature of the active material and the solid electrolyte (when present). In some embodiments, the additive lowers the sintering temperature of the active material (e.g., by 100° C. or more) and the solid electrolyte (e.g., by 100° C. or more).

In some embodiments, the low melting point additive has an interfacial energy of less than 1 J/m² (e.g., less than 0.8 J/m2, less than 0.6 J/m2, or less than 0.4 J/m2). In some embodiments, the additive has a melting point of less than or equal to (≤) 1000° C. (e.g., less than or equal to 900° C., less than or equal to 800° C., less than or equal to 700° C., or less than or equal to 650° C.). In certain embodiments, the additive is in the form of an interphase layer having a thickness of from 20 nm to 300 nm. The interphase layer can be between particles of active material and/or solid electrolyte, when present. The interphase layer can be uniformly dispersed between particles of active material and/or solid electrolyte. In some embodiments, the interphase layer can be homogeneously dispersed between particles of active material and/or solid electrolyte. In certain embodiments, the interphase layer is present in a larger amount in a portion of particles of active material and/or electrolyte, while being in a smaller amount in a different portion of particles of active material and/or electrolyte. The interphase layer between particles of active material and/or solid electrolyte can be distinctive and can be observed by microscopy (e.g., scanning electron spectroscopy).

In some embodiments, the cathode has an areal capacity of 4 mAh/cm² or more (e.g., 6 mAh/cm² or more, 8 mAh/cm² or more, 10 mAh/cm² or more, or 15 mAh/cm² or more) and an active material loading of 30 mg/cm² or greater (e.g., 40 mg/cm² or greater, 50 mg/cm² or greater, 60 mg/cm² or greater, or 70 mg/cm² or greater). The area capacity can be determined by measuring the capacity of the cathode in electrochemical cells, then dividing the obtained capacity by the area of the cathode. The active mass load per unit area can be determined by dividing the total mass of the active cathode materials by the cathode area. The mass of the active cathode materials is the total electrode (cathode) mass minus the mass of the current collector and the mass of the additives. Methods of determining the areal capacity, active mass load per unit area, and the mass of the active cathode material are described, for example, in Electrochemical Methods: Fundamentals and Applications, Allen J. Bard and Larry R. Faulkner, Wiley; 2nd edition (Dec. 18, 2000), incorporated herein by reference in its entirety.

In some embodiments, the cathode has an ionic conductivity of 1×10⁻⁴ S cm⁻¹ or more (e.g., 3×10⁻⁴ S cm⁻¹ or more, 5×10⁻⁴ S cm⁻¹ or more, or 7×10⁻⁴ S cm⁻¹ or more). The ionic conductivity can be measured, for example, using electrochemical impedance spectroscopy, as described, for example, in Electrochemical Methods: Fundamentals and Applications, Allen J. Bard and Larry R. Faulkner, Wiley; 2nd edition (Dec. 18, 2000), incorporated herein by reference in its entirety.

In some embodiments, the cathode has an electronic conductivity of 1×10⁻³ S cm⁻¹ or more (e.g., 3×10⁻³ S cm⁻¹ or more, 5×10⁻³ S cm⁻¹ or more, or 7×10⁻³ S cm⁻¹ or more). The electronic conductivity can be measured, for example, using electrochemical impedance spectroscopy, as described, for example, in Electrochemical Methods: Fundamentals and Applications, Allen J. Bard and Larry R. Faulkner, Wiley; 2nd edition (Dec. 18, 2000), incorporated herein by reference in its entirety.

In certain embodiments, the cathode does not include a solid electrolyte. In some embodiments, the lithium solid state battery includes a Li-metal anode and a gel electrolyte between the cathode and the anode. Gel electrolytes are described, for example, in PEO-Polymer Electrolyte Based All-Solid-State Supercapacitors: An Experimental Study, Y. Yin, VDM Verlag Dr. Müller (Oct. 24, 2010), incorporated herein by reference in its entirety.

In certain embodiments, the lithium solid state battery has an ionic resistance of 100 cm² or less (e.g., 80 Ωcm² or less, 60 Ωcm² or less, or 50 Ωcm² or less). The ionic resistance can be measured using electrochemical impedance spectroscopy, as described in Electrochemical Methods: Fundamentals and Applications, Allen J. Bard and Larry R. Faulkner, Wiley; 2nd edition (Dec. 18, 2000), incorporated herein by reference in its entirety.

In some embodiments, the lithium solid state battery includes an interfacial resistance of 500 Ωcm² or more (e.g., 450 Ωcm² or less, 400 Ωcm² or less, 350 Ωcm² or less, or 300 Ωcm² or less). Interfacial resistance can be measured by, for example, electrochemical impedance spectroscopy, as described in Electrochemical Methods: Fundamentals and Applications, Allen J. Bard and Larry R. Faulkner, Wiley; 2nd edition (Dec. 18, 2000), incorporated herein by reference in its entirety.

In some embodiment, the lithium solid state battery has a total charge transfer resistance of 1000 Ωcm² or more (e.g., 1200 Ωcm² or more, 1400 Ωcm² or more, or 1600 Ωcm² or more). The total charge transfer resistance can be measured, for example, using electrochemical impedance spectroscopy, as described in Electrochemical Methods: Fundamentals and Applications, Allen J. Bard and Larry R. Faulkner, Wiley; 2nd edition (Dec. 18, 2000), incorporated herein by reference in its entirety.

The lithium solid state battery can have a charge/discharge capability of 50 cycles or more (e.g., 60 cycles or more, 80 cycles or more, or 100 cycles or more) with more than 80% (e.g., more than 85%, more than 90%, or more than 95%) of the initial capacity at the end of the cycle. The charge/discharge capability can be measured by conducting a constant current constant voltage (CCCV) charge−constant current (CC) full discharge at a temperature of about 55° C., as described, for example, in Electrochemical Methods: Fundamentals and Applications, Allen J. Bard and Larry R. Faulkner, Wiley; 2nd edition (Dec. 18, 2000), incorporated herein by reference in its entirety.

In some embodiment, the lithium solid state battery has an initial capacity of 150 mAh/g or more (e.g., 200 mAh/g or more, 250 mAh/g or more, 300 mAh or more, or 400 mAh/g or more). As used herein, the initial capacity refers the discharge capacity of the first charge/discharge cycle. The lithium solid state battery can have a decrease in capacity of less than 10% (e.g., less than 8%, less than 6%, or less than 4%) over 40 charge/discharge cycles at a temperature of 55° C.

### Methods of Making

The present disclosure also describes a method of making a cathode for a lithium solid state battery. For example, a lithium-containing cathode active material, an optional solid electrolyte, and an additive having a lower melting point than the active material can be mixed to provide a mixture, then the mixture can be sintered to provide the cathode.

Mixing the lithium-containing cathode active material, the optional solid electrolyte, and the additive can be performed, for example, using a mortar and pestle (e.g., an agate mortar), an automatic mixer, or the like, for a duration of, for example, 0.5 hour to 1 hour, at room temperature.

Sintering can be performed, for example, using spark plasma sintering or hot-pressing, for a period of, for example, from 5 minutes to 10 minutes, at a temperature of, for example from 580° C. to 700° C. (e.g., from 600° C. to 700° C., from 600° C. to 650° C.) under an inert atmosphere.

The cathode can be made in a pellet form, for example, having a diameter of about 0.5 inch and a thickness of 0.1 mm to 2 mm.

### Battery Assembly

The cathodes of the present disclosure can be incorporated into a solid state battery. For example, a lithium solid state battery can be made by providing a cathode made according to the methods herein and assembling the cathode with a gel electrolyte and a lithium anode to provide the lithium solid state battery. The solid state battery can be in the form of a coin cell or a pouch cell. Methods of assembling a solid state battery, such as a coin battery, are described, for example, in B. Long, S. Rinaldo, K. Gallagher, D. Dees, S. Trask, B. Polzin, A Jansen, D. Abraham, I. Bloom, J. Bareno, J. Croy, “Enabling High-Energy, High-Voltage Lithium-Ion Cells: Standardization of Coin-Cell Assembly, Electrochemical Testing, and Evaluation of Full Cells” Journal of The Electrochemical Society, 163 (14) A2999-A3009 (2016), incorporated herein by reference in its entirety. Methods of assembling a pouch battery are described, for example, in Wu B., Y. Yang, D. Liu, C. Niu, M. E. Gross, L. M. Seymour, and H. Lee, et al. 2019. “Good Practices for Rechargeable Lithium Metal Batteries.” Journal of the Electrochemical Society 166, no. 16:A4141-A4149, incorporated herein by reference in its entirety.

The following example is included for the purpose of illustrating, not limiting, the described embodiments. The following Example describes solid state batteries including a cathode that includes a low melting point additive.

### Example

Solid-state batteries (SSBs) could significantly improve safety and energy density over the liquid cells. One key enabling technology is the high energy all ceramic cathodes. NASICON-type Li_{1.3}Al_{0.3}Ti_{1.7}(PO₄)₃ (LATP) is considered as one of the most attractive solid-state electrolytes on the cathode side due to its high oxidation potential and high ionic conductivity. The usage, however, is limited by its large interfacial resistances against most of the cathode materials, due to the chemical potential incompatibility as well as the thermodynamic instability during high temperature sintering that is usually needed to achieve high mass density. The present Example demonstrates that thin, percolative, and mixed conductive interphases could be obtained by in situ sintering using a low-melting-point sintering additive. These mixed conductive interphases dramatically improved the kinetics, leading to high-loading solid LATP/LiCoO₂ cathodes up to ˜6 mAh cm⁻². The technique is also applicable to Ni-rich cathode materials, achieving up to ˜10 mAh cm⁻², which is expected to enable 400 Wh kg′ in SSBs. The composite cathodes showed ten-times and three-times area capacity improvement over the state-of-the-art cathodes using oxide and sulfide SSEs, respectively.

The present Example shows that additives, such as a B₂O₃ additive, lowered the sintering temperature of Li_{1.3}Al_{0.3}Ti_{1.7}(PO₄)₃ (LATP), and facilitated the formation of thin, percolative, and mixed conductive interphases between LATP/LCoO₂. The mixed conductive interphases enabled fast ion and electron transport, leading to high-loading of solid LATP/LiCoO₂ cathodes at up to ˜6 mAh cm⁻². Formation of mixed conductive interphases was also demonstrated for Ni-rich oxide cathode materials, exhibiting up to ˜10 mAh cm⁻², which was calculated to achieve a 400 Wh kg⁻¹ SSB.

Liquid phase sintering with low-melting-point additives was demonstrated to not only lower the sintering temperature for limiting the interfacial reactions, but also offered an additional opportunity to form conductive interphases. B₂O₃ was used for sintering high-density SSEs. Importantly, the lower melting point of B₂O₃ (˜450° C.) made it an ideal additive for low-temperature sintering. With the B₂O₃ additive, the sintering temperature could be successfully lowered while retaining a high relative density and a high ionic conductivity. In addition, liquid phase additive during sintering also largely limited side reactions between LATP and LCO, retaining the electrochemical activity of LCO. In the composite cathode of the present Example, a thin mixed conductive Li₃PO₄/Co₃O₄ interphase was formed, enabling fast ion and electron transport. Furthermore, the liquid phase additive during sintering considerably wet the LATP and LCO particles, improved the mechanical contacts, and formed a percolation network. High-energy SSBs were successfully prepared, using the Li anode, LATP SSE, and LATP/LCO composite cathode; which exhibited high areal capacity of 4.7-6.4 mAh cm⁻² cycled at 3.0-4.5 V. The superior electrochemical performance of the SSBs of the present Example was accomplished by in situ formed interphases during a low-temperature sintering process. This was an important factor for achieving high areal energy density in the designed SSBs. The liquid phase sintering technique was also applied in the fabrication of high capacity LiNiₓMn_{y}Co_{z}O₂ (NMC) cathode, which contains 98% active materials and showed a density of 4.3 g cm⁻³. Thus, an efficient approach to sinter high energy cathode (˜170 mAh g⁻¹ and ˜10 mAh cm⁻²) was demonstrated, which was expected to achieve high energy density in pouch SSBs (>400 Wh Kg⁻¹).

SSEs and Composite Cathodes Fabrication

LATP and LABTP were synthesized via a solid-state reaction method. The starting materials were LiOH.H₂O (99.95%, Sigma Aldrich), Al₂O₃ (99.99%, Sigma Aldrich), TiO₂ (99.8%, Sigma Aldrich), and NH₄H₂PO₄ (99.5%, Sigma Aldrich) powders. LiOH.H₂O was heated at 250° C. for 3 h to remove the crystalline H₂O prior to use. Stoichiometric amounts of chemicals with 10 wt. % excess LiOH (for compensating Li losses during the subsequent high temperature processing) were hand-ground for 0.5 h in an agate mortar. The mixed powders were then cold pressed into pellets with a diameter of 13 mm at 400 MPa. The pellets were then pre-heated at 400° C. in air for 5 h, hand-ground into fine powders, and cold pressed into pellets again. These pellets were subsequently heated in air at 900° C. for 5 h and then pulverized into fine powders. For LABTP synthesis, 1 wt. % B₂O₃ (99.98%, Sigma Aldrich) was added. The LATP and LABTP fine powders were sintered into dense pellets by spark plasma sintering (SPS) under 35 MPa for 5 min. at 900° C. and 750° C., respectively. The sintered pellets were then cut, polished, ultrasonically cleaned in alcohol for 5 min., and stored in an Ar-filled glovebox (H₂O<0.5 ppm, O₂<0.5 ppm, Lab Star, Mbraun, Germany) for avoiding the surface contaminations.

For fabricating composite cathodes, LATP or LABTP and LCO powders (MTI, USA) with different mass ratios (1:1, 3:7, and 1:9) were mixed by hand-grinding in an agate mortar for 0.5 h. The well-mixed powders were SPS sintered at 580-700° C. for 2 min. under 35 MPa. The as-sintered pellets were cut and polished into thin pellets with a thickness ranging from 180 to 300 μm. To sinter LABTP/LCO-LABTP heterogenous pellets, the mixed LABTP/LCO powders were sprayed on a LABTP pellet in a graphite die with a diameter of 10 mm which was subjected to a second SPS sintering at various temperatures for 2 min under 35 MPa. The sintered heterogenous pellets were then polished and ultrasonically cleaned. The thickness of composite cathode was controlled to be 100-300 μm, while the LABTP thickness was around 200 μm. NMC622/B₂O₃ were also prepared by a liquid phase sintering technique. NMC622 with 2 wt. % B₂O₃ or 5 wt. % B₂O₃ was mixed by hand-grinding in an agate mortar for 0.5 h.

Characterization

Phase compositions of the synthesized LABTP powders, LABTP/LCO, and NMC622/B₂O₃ composite cathodes were characterized by X-ray diffraction (XRD) (Cu K_{α}, λ˜0.15406 nm, Bruker D8 Advance, Germany). Morphologies and chemical compositions of the sintered sample fractured surfaces were examined using a field-emission scanning electron microscope (SEM, Sirion XL30, FEI, USA) equipped with an Oxford energy-dispersive X-ray spectroscopy (EDS). The microstructures and compositions of the LABTP/LCO cathodes were also analyzed by a transmission electron microscope (TEM) equipped with a high-angle annular dark-field (HAADF) detector and an EDS at the Pacific Northwest National Laboratory (STEM/HAADF/EDS, FEI Titan 80-300 kV, USA). Electrochemical impedance spectroscopy (EIS) tests of LABTP, LABTP/LCO, and NMC622/B₂O₃ composite pellets were performed using an electrochemical workstation (Biologic SP-300, French) in the temperature range from 25 to 80° C. Prior to the EIS tests, Ag paste was sprayed on both sides of pellets and heated at 80° C. for 2 h to evaporate the solvent. EIS tests were carried out in the frequency range between 7 MHz and 0.1 Hz with an AC amplitude of 10 mV. The electrical conductivity was estimated by the formula, σ=d/RA, where d is the pellet thickness, A the surface area, and R the resistance obtained from the EIS measurements. R values were approximately taken as the low frequency intercepts with the real axis, which is well consistent with the fittings using the equivalent circuit models.

The magic angle spinning nuclear magnetic resonance (MAS NMR) technique was used to probe the local chemical environment of the atoms and to analyze the Li dynamics of the materials. The ⁷Li, ²⁷Al, and ³¹P MAS NMR spectra were acquired at Larmor frequencies of 58.9, 104.3, and 162.0 MHz, on a Bruker Advance III 400 MHz spectrometer with a sample spinning rate of 12 kHz. The chemical shifts of the ⁷Li, ²⁷Al, and ³¹P spectra were calibrated by using 1M aqueous LiCl solution (0 ppm), Al(OH)₃ (0 ppm), and NH₄H₂PO₄ (0 ppm), respectively. ²⁷Al MAS NMR spectra were collected using a pulse length of 0.6 us and a recycle delay of 2 s. ³¹P MAS NMR spectra were collected using a pulse length of 2.7 μs and a recycle delay of 60 s. ⁷Li MAS NMR spectra were collected using a ¼ π pulse and a recycle delay of 30 s. The ⁷Li-⁷Li exchange spectra were recorded with a mixing time of 20 ms.

Electrochemical Performance Test

To study the electrochemical behavior of the LABTP/LCO and NMC622/B₂O₃ composite cathodes, both semi-solid and solid cells were assembled, and the composite cathodes were sputtered with ˜200 nm Au on one side as the current collector. After vacuum dry at 80° C. for 2 h, the cathode pellets were transferred into an Ar-filled glove-box (H₂O<0.5 ppm, O₂<0.5 ppm, Lab Star, Mbraun, Germany) for battery assembly. The composite cathodes were assembled in CR2032 coin cells, with Li metal anodes (250 μm thick, MTI Corporation, USA) and Celgard PP 2500 separators wet by ˜20 μL carbonate electrolytes (1.2 M LiPF₆ in ethylene carbonate (EC)/ethyl methyl carbonate (EMC)=3:7 by weight with 2 wt. % vinylene carbonate (VC)). To assemble the solid-state cells contained LABTP/LCO cathodes, a poly(vinylidene fluoride-co-hexafluoropropylene) (PVDF-HFP) gel electrolyte was fabricated. PVDF-HFP (M_{w}≈455,000, Sigma-Aldrich) was dissolved in acetone (˜1:10.5 by weight) in a glass container by stirring at 60° C. for 2 h. The obtained uniform slurry was spray coated by a doctor-blade on a piece of clean glass plate, then dried in a vacuum oven for 12 h at 60° C. to remove the solvent. The as-prepared PVDF-HFP membrane (˜60 μm in thickness) was cut into sheets with a diameter of 16 mm and transferred into the Ar-filled glovebox, which were then immersed into the same liquid electrolyte for 2 h for activation. The electrolyte residue was removed by a paper wipe in the glovebox. The as-obtained PVDF-HFP gel electrolyte sheet was inserted between the LABTP/LCO-LABTP heterogeneous pellet and Li metal and then sealed in a CR2032 cell. The electrochemical performance was tested using a Landt battery tester (CT2001A, Wuhan, China).

To evaluate the electrochemical window of the LABTP, 60 wt. % LATP or LABTP powders, 20 wt. % conductive carbon black, 20 wt. % PVDF were mixed with a few drops of NMP to form a homogeneous slurry. The slurry was spray coated onto an Al foil (20 μm thick), and vacuum dried at 80° C. for 24 h. The dried coating was punched into circular sheets with a diameter of 10 mm. The LABTP electrode sheet was assembled into a 2032-type coin cells with Li metal as the counter electrode, the same carbonate electrolytes, and Celgard PP2500 separator. Cyclic voltammograms (CV) were collected between 2.0 and 4.5 V (vs. Li⁻¹/Li) using a VersaSTAT 4 potentiostat (Ametec Scientific Instruments, USA), with a scanning rate of 0.1 mVs⁻¹.

Computational Method

Density functional theory (DFT) calculations were performed within the generalized gradient approximation (GGA) with the Perdew, Burke and Ernzerhof (PBE) exchange-correlation functionals, using a planewave basis set and the projector augmented wave (PAW) method as implemented in the Vienna Ab initio Simulation Package (VASP). Energy cutoff for the plane waves is set to be 500 eV. The convergence thresholds for self-consistency and forces are 10⁻⁵ eV and 10⁻² eV/Å, respectively, for all calculations.

To examine the thermodynamics stability between LATP and LiCoO₂, the reaction energy and the decomposition products formed at the interfaces were determined by calculating the energy at the facets along the tie-line between LATP and LiCoO₂. The reaction energy was calculated by

ΔE=E(phase equilibria)−xE(LATP)−E(LiCoO₂),

where E(LATP) and E(LiCoO₂) were the total energy of LATP and LiCoO₂, respectively, and x was a parameter that can vary between 0 and 1. E (phase equilibria) represents the total energy of the product phases. The minimum energy along this tie-line was considered to be the most likely reaction phases.

Design and Areal Capacity of LABTP/LCO Cathodes

For comparative studies of SSB, the cathode slurries, composed of active material powders, SSE powders and polymer binder, were cast on dense SSE pellets. Low melting point binder (e.g., Li₃BO₃ or Li_{2+y}C_{1-y}B_{y}O₃) and post heat treatment were carried out to improve the interfacial contacts. This, however, could not lead to thick cathodes due to the slurry coating technique used, the high binder contents, and the relatively low-conductivity interfaces/interphases. In addition, the evaporation of solvents and oxidation of polymer binder during heat treatment normally released gases and generated pores in the composite cathode, thus showing low energy density.

The energy density was calculated based on the SSB configuration which contained the pouch (included tabs), the Al foil (12 μm), the composite cathodes (LABTP/LCO or NMC622/B₂O₃), the LATP SSE, the PVDF-HFP gel electrolyte, and the Li metal (50 μm) on copper foil 6 μm). In general, the energy density of an SSB is the energy density of composite cathode divided by the total mass. The SSB energy density can be described as

$${E}_{SSE} = \frac{{C}_{c} \times {V}_{c} \times {ρ}_{c} \times {d}_{c} \times R}{\begin{matrix}{m}_{pouch} + {ρ}_{Al} \times {d}_{Al} + {ρ}_{Cu} \times {d}_{Cu} + {ρ}_{c} \times {d}_{c} + {ρ}_{SSE} \times {d}_{SSE} + \\ {ρ}_{Gel} \times {d}_{Gel} + {ρ}_{Li} \times {d}_{Li} + {ρ}_{Cu} \times {d}_{Cu}\end{matrix}} .$$

in which the pouch size and weight is 4.5×3.6 cm² and 1.24 g, respectively; the total weight of Al and Ni tabs is 0.24 g; C_{c} is the capacity of the composite cathode (110 mAh g⁻¹ for LABTP/LCO-200 μm, 90 mAh g⁻¹ for LABTP/LCO-300 μm, and 170 mAh g⁻¹ for NMC622/B₂O₃); V₇ is the average working voltage of the composite cathodes (3.9 V for LABTP/LCO, and 3.7 V for NMC622/B₂O₃); p_{c} is the density of the composite cathodes (3.4 g cm⁻³ for LABTP/LCO, and 4.3 g cm⁻³ for NMC622/B₂O₃); d_{c} is the thickness of the composite cathode; R is the ratio of active materials (70% for LABTP/LCO, and 98% for NMC622/B₂O₃) in the composite cathodes; ρ_{Al} is the density of the Al current collector (2.7 g cm⁻³); d_{Al} is the thickness of the Al current collector (12 μm); ρ_{SSE} is the density of LATP layer (2.98 g cm⁻³); d_{SSE} is the thickness of the SSE layer; ρ_{Gel} the density of the PVDF-HFP gel electrolyte (1.0 g cm⁻³); d_{Gel} is the thickness of the PVDF-HFP layer (60 μm); ρ_{Li} is the density of the Li metal (0.53 g cm⁻³); d_{Li} is the thickness of the Li metal (50 μm); ρ_{Cu} is the density of copper current (8.96 g cm⁻³); and d_{Cu} is the thickness of the Cu current collector (6 μm). Taking NMC622/B₂O₃ as an example, the details are shown in Table 1.

TABLE 1

| | The energy density calculations of the NMC622/B₂O₃(2 wt. %) cathode sealed in | | | | | |
|---|---|---|---|---|---|---|
| | a pouch cell (20 layers). | | | | | |
| | | Calculation | Weight | | Energy | |
| Cathode | NMC622/B₂O₃ | 4.3 g/cm³ × 0.012 cm × 5.4 cm × | 20.062 | g | | |
| | (2 wt. %) | 3.6 cm × 2 × 10 | | | | |
| | 120 μm thick | layers | | | | |
| | 12 μm Al foil | 2.7 g/cm³ × 0.0012 cm × 5.4 cm × | 0.693 | g | | |
| | | 3.6 cm × 11 layers | | | | |
| | Capacity | 170 mAh/g × 20.062 g | | | 3.41 | Ah |
| LATP SSE | 50 μm thick | 2.95 g/cm³ × 0.005 cm × 5.4 cm × | 5.74 | g | | |
| | | 3.6 cm × 2 × 10 layers | | | | |
| PVDF-HFP | 60 μm thick | 1 g/cm³ × 0.0060 cm*5.4 cm × | 2.33 | g | | |
| | | 3.6 cm × 2 × 10 layers | | | | |
| Anode | 50 μm Li | 2.53 g/cm² × 5.55 cm × | 1.053 | g | | |
| | | 3.75 cm × 2 × 10 layers | | | | |
| | 6 um Cu foil | 8.9 g/cm³ × 0.0006 cm × 5.55 cm × | 1.111 | g | | |
| | | 3.75 cm × 10 layers | | | | |
| Package foil | 115 μm | 1.24 g | 1.24 | g | | |
| Tab | one pair | Ni tab and Al tab | 0.23 | g | | |
| Voltage | | | | | 3.7 | V |
| Energy | | | | | 12.617 | Wh |

| Total weight | | 32.459 | |
|---|---|---|---|
| Specific Energy | 20 layers | 388 | Wh/Kg |

Liquid-phase sintering with low-melting-point additives could be used to enhance densification rates, achieve accelerated grain growth, or produce specific grain boundary properties at lower temperatures. More importantly this technique allowed the fabrication of much thick cathodes (˜mm), necessary for achieving high energy density in SSBs. FIG. 1A showed the dihedral angel (ψ) between the solid-liquid interfaces with the solid-solid specific energy γₛₛ and solid-liquid specific energy γₛₗ. The wetting of grain boundaries occurred when 2 γₛₗ<γₛₛ. Thus, without wishing to be bound by theory, it is believed that additives with lower γₛₗ could promote wetting of the grains during sintering. Liquid phase B₂O₃ exhibited extremely low interfacial energy (0.08 J m⁻²) comparable to water (0.072 J m⁻²) and its melting point was 450° C. and could be effective as an additive for sintering LATP and LCO.

Here, to achieve lower temperature liquid phase sintering, 1 wt. % B₂O₃ was added to LATP (denoted as LABTP). Heterogeneous SSE/cathode composites could be successfully achieved by spark plasma sintering (SPS) LABTP/LCO powders on a dense LABTP pellet. FIG. 1B showed a schematic of sintered LABTP/LCO on LABTP showing interphases which was ˜200 nm in the present Example (discussed below). By adding B₂O₃, the sintering temperature of LATP could be reduced from 900° C. to 750° C., while retaining a high relative density of >99% and an ionic conductivity of 7.7×10⁻⁴ S cm⁻¹ at 25° C. (FIG. 1C). In addition, the mixed conductive interphases solidified from liquid phase enable the composite cathode (0.2-0.3 mm) possessing high ionic and electronic conductivities of ˜7.0×10⁻⁵ S cm⁻¹ and ˜1.6×10⁻³ S cm⁻¹, respectively (FIG. 1C). The SSBs with the LABTP/LCO-LABTP-Li (cathode-SE-anode) configuration exhibited areal capacities up to 6.4 mAh cm⁻² at a voltage window of 3.0-4.4 V, which was a ten-times and three-times improvement over the state-of-the-art cathodes using oxide and sulfide SSEs, respectively (FIG. 1D).

Low Temperature Sintering of LABTP Solid Electrolyte

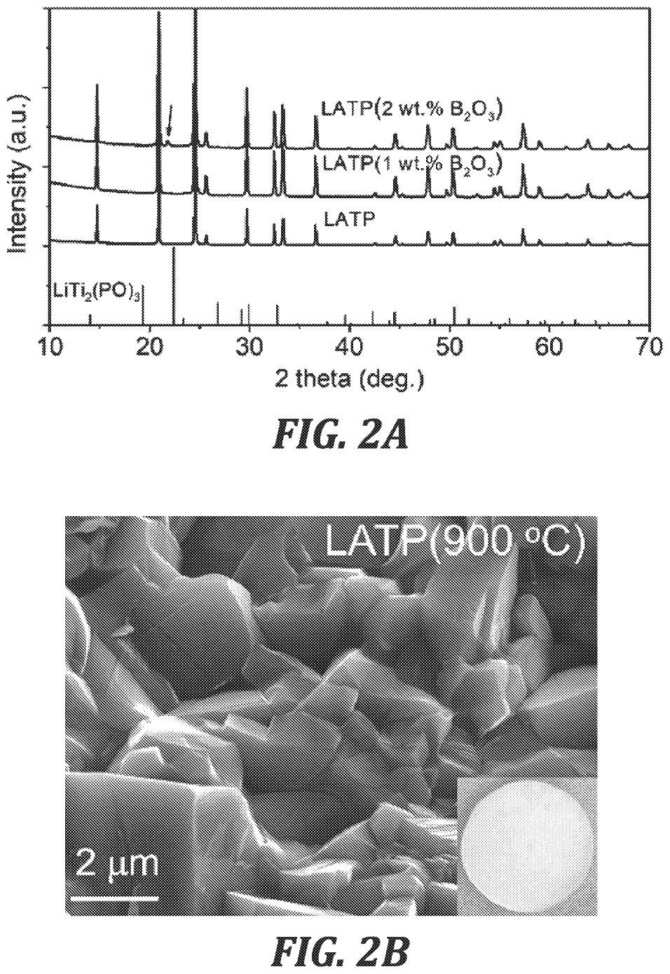

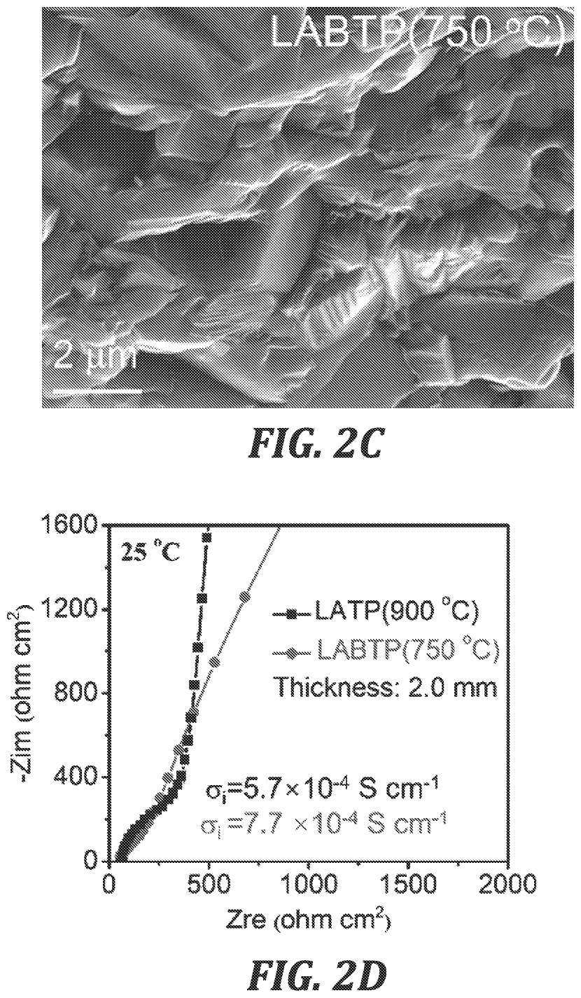

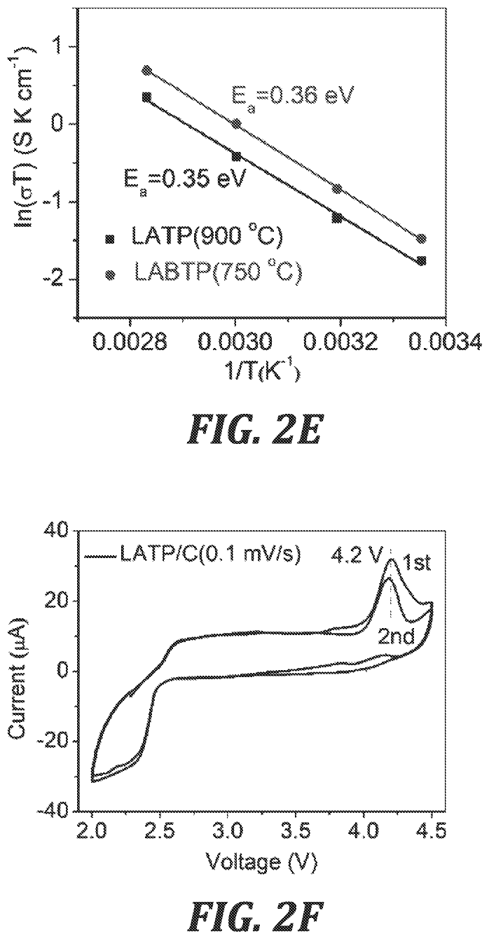

As shown in FIG. 2A, X-ray diffraction (XRD) patterns indicated the successful syntheses of phase pure LATP with the NASICON structure (JCPDS 35-754), and no impurity phase was detected for 1 wt. % B₂O₃ addition. For 2 wt. % B₂O₃, however, an AlPO₄ impurity was observed. In addition, there was no change in lattice parameters with the addition of B₂O₃, indicating that B₂O₃ did not enter the LATP lattice but rather formed a surface coating layer. Thus, LATP with 1 wt. % B₂O₃ addition was selected for the following study due to its pure phase and high ionic conductivity. Scanning electron microscope (SEM) images of fractural surfaces of the LATP and LABTP pellets (FIGS. 2B and 2C) showed similarity even with different sintering temperatures (900° C. vs 750° C.). The grains displayed a typical morphology of cubic crystals with sharp grain boundaries, and compacted closely without any noticeable void, well consistent with the high mass density (>99% relative density). Furthermore, LATP mostly showed intergranular fractures, while LABTP displayed a much higher ratio of intra-granular fractures, implying stronger inter-grain binding for LABTP.

FIG. 2D compared the Nyquist plots of LATP and LABTP at 25, 40, 60, and 80° C. and the equivalent circuit. It was evident that the LABTP showed a lower grain boundary resistance (R_{g}b, 209 Ωcm²) than that of pure LATP (275 Ωcm²), attributable to the high degree of densification by the liquid phase sintering. Consequently, the total ionic conductivity of LABTP was ˜7.7×10⁻⁴ S cm⁻¹, about 35% higher than that of LATP (˜5.7×10⁻⁴ S cm⁻¹). The ionic conductivity improvement for LABTP mainly originated from the decreased grain boundary resistance, as evidenced by their comparable bulk conductivities. The Arrhenius plots (ln(σT) vs. 1/T) of total ionic conductivity were plotted in FIG. 2E, and the activation energies of LABTP and LATP were estimated to be 0.36 eV and 0.35 eV, respectively. This indicated that B₂O₃ addition did not change the conduction mechanism of LATP, in good agreement with the results of XRD. The intrinsic electrochemical window was shown in the cyclic voltammograms (CV) using LATP/C and LABTP/C electrodes. As shown in FIG. 2F, the oxidation of both LATP and LABTP started at ˜4.2 V and the reduction at 2.8 V, consistent with the theoretical calculations.

Mixed Conductive Interphases of the LABTP/LCO Composite Cathodes

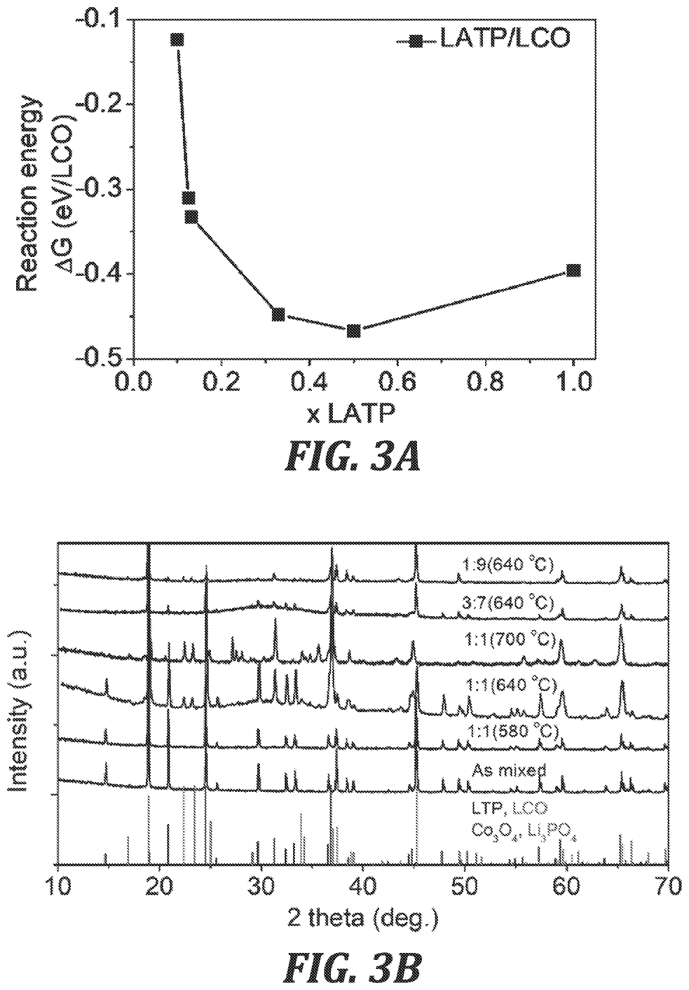

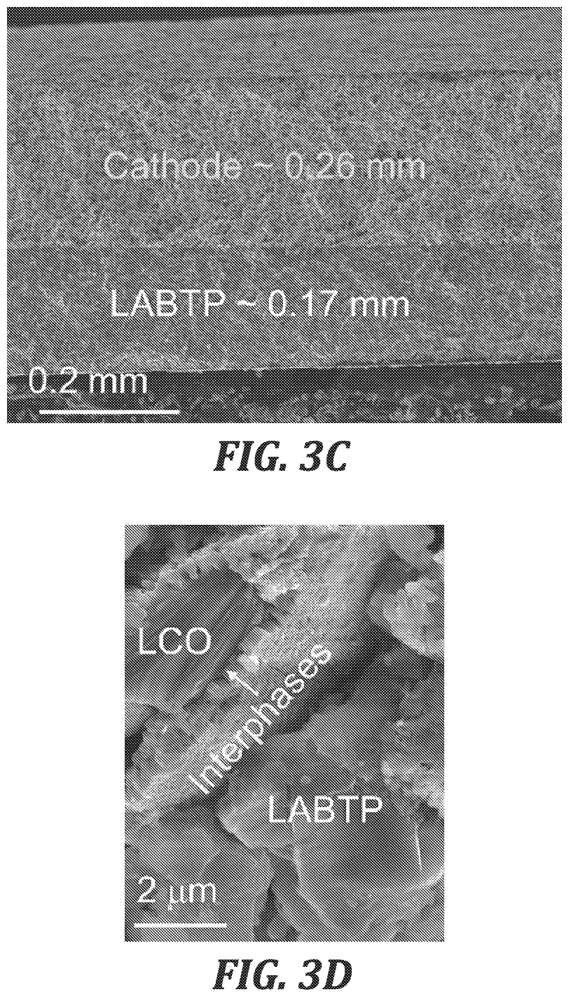

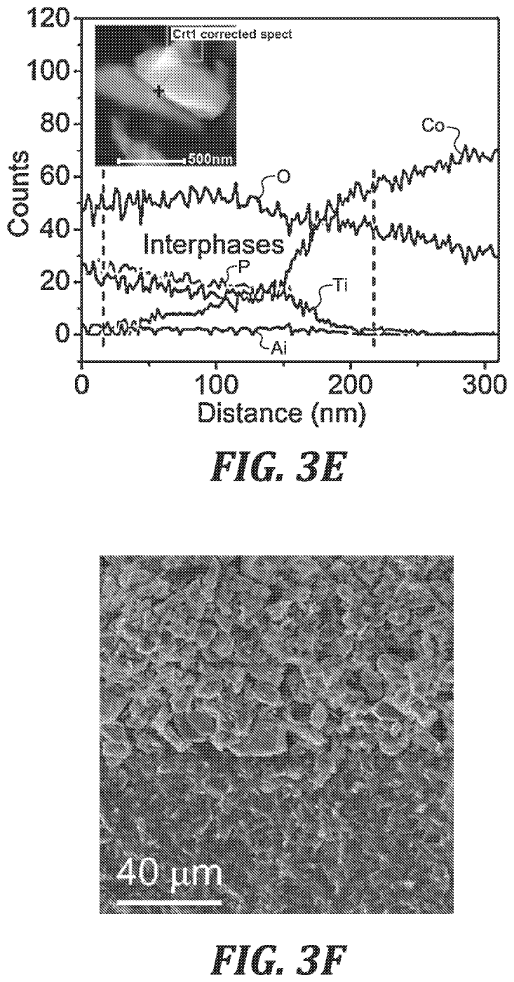

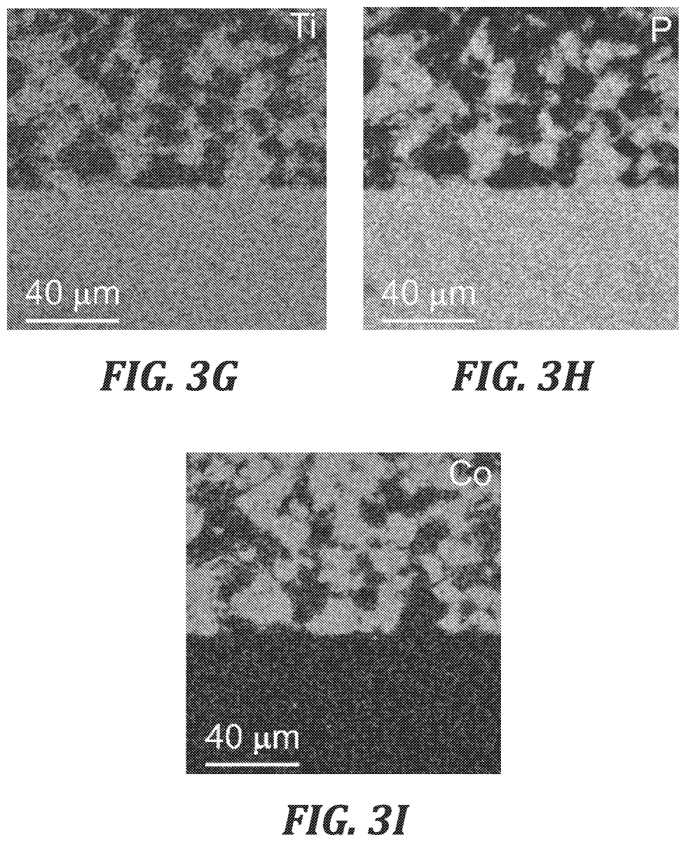

The thermodynamic phase stability of LATP/LCO were evaluated by density functional theory (DFT) calculations. The reaction energy between LATP and LCO was shown in FIG. 3A, the chemical reaction of LATP/LCO at a molar ratio of 0.33 was

12Li_{1.5}Al_{0.5}Ti_{1.5}(PO₄)₃+36LiCoO₂→12Li₃PO₄+6AlPO₄+18LiTiPO₅+9Co₃O₄+9CoO₂,

with ΔG=−16.13 eV.

The large negative Gibbs free energy value indicated that thermodynamically LATP was highly reactive with LCO at ambient conditions. This was validated by the XRD pattern of the LATP/LCO powders sintered at 640° C., in which the predicted byproducts Li₃PO₄, LiTiPO₅ and Co₃O₄ were detected. With the liquid B₂O₃ additive, only Li₃PO₄ and Co₃O₄ appeared after sintering at 640° C. (FIG. 3B). In FIG. 3B and the remaining manuscript, the ratio between LABTP and LCO was based on wt. %, denoted as 1:1, 3:7, and etc. The LiTiPO₅ was not found until 700° C., when LCO decomposed. Solid-state nuclear magnetic resonance (NMR) spectroscopy further confirmed the in situ formed interphases during sintering. ³¹P magic angle spinning (MAS) NMR spectra of the as-mixed LABTP/LCO showed the same spectra with that of LABTP. After sintering, a new ³¹P NMR peak at 9.6 ppm was observed, identified as Li₃PO₄. The small peak at −10 ppm was assigned to a small amount of LiTiPO₅ in the interphases. Ionic conductivities of LiTiPO₅ and Li₃PO₄ were reported to be ˜10⁻⁷ S cm⁻¹ and Co₃O₄ is a p-type semiconductor. To enable a high conductivity of the composite cathode, the interphase layer should be kept thin enough and LCO has to be well preserved. Thus, 640° C. was chosen as the sintering temperature.

The composite cathodes were successfully SPS sintered (640° C.) on the top of dense LABTP pellets (sintered at 750° C.). FIG. 3C showed the fractural surface morphology for the LABTP/LCO-LABTP heterogenous pellet, the thick composite cathode (˜0.26 mm) was densely sintered and well attached to the condense LABTP pellet (˜0.17 mm). The interphase layer with a well-aligned nanopillars configuration welded the LABTP and LCO particles well, as shown in FIG. 3D. The energy-dispersive X-ray spectroscopy (EDS) line scan across the LABTP/LCO interface further confirmed that the interphases mainly consisting of Co₃O₄, Li₃PO₄, and LiTiPO₅ with an interdiffusion layer thickness of ˜200 nm (FIG. 3E). These uniform, thin interphases could improve the mechanical robustness of the ceramic cathode. The well-defined, closely integrated interfaces were also observed between the composite cathode layer and the LABTP layer (FIG. 3F). As shown in FIG. 3G-3I, the EDS mapping of Ti, P, and Co elements further confirmed the cross-linked cathode structure and the well welded SSE/cathode interfaces, which facilitated good ionic and electronic transport.

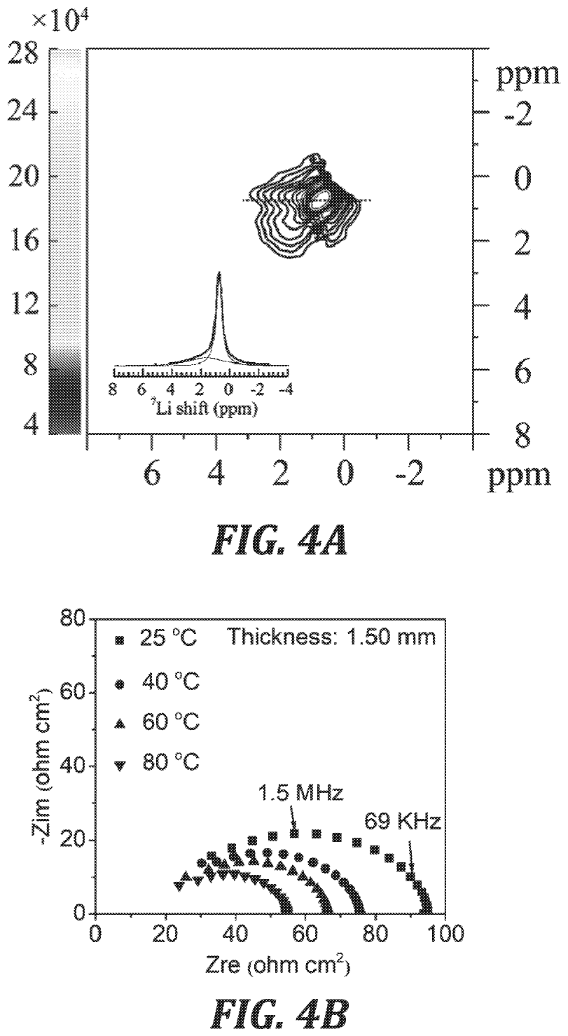

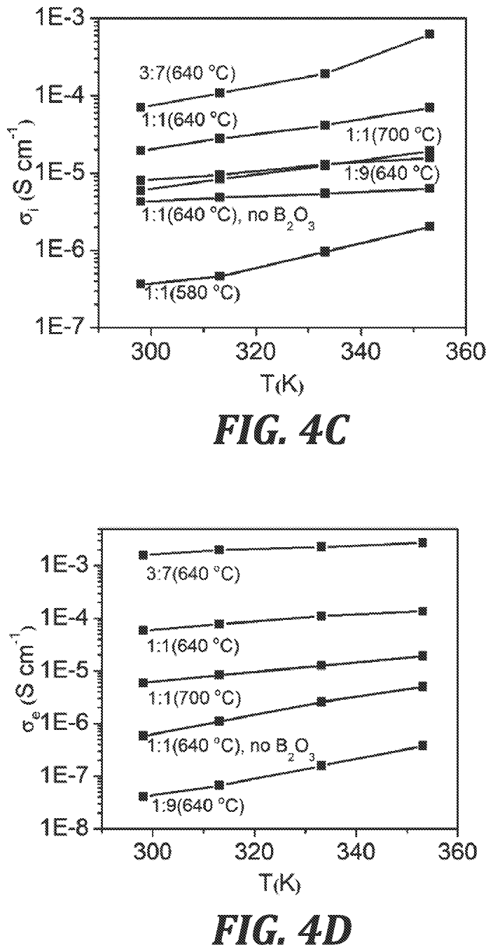

FIG. 4A is the two-dimensional exchange NMR spectroscopy (2D-EXSY) of the composite cathode LABTP/LCO-1:1 (the ratio is based on wt. % as denoted previously). The resonant signal occurring in the diagonal direction represented the one-dimensional (1D) NMR contribution from Li chemical shift of the pristine LCO and pristine LABTP at 0.7 and 1.6 ppm, respectively. The off-diagonal intensity quantified the amount of lithium ions that spontaneously moved between the electrode and the electrolyte, shown as the swell marked by the dashed line in FIG. 4A. The inset of FIG. 4A is the derived 1D NMR spectrum representing the Li⁺ exchange between the LABTP and LCO, with a peak at around 1.6 ppm. This was a direct experimental evidence for Li⁺ transfer between the cathode active material and the SSE.

To determine the electrical conductivity of the composite cathodes, electrochemical impedance spectroscopy (EIS) tests were carried out. The EIS model determining the ionic and electronic conductivities was as described in S. Wang, M. Yan, Y. Li, C. Vinado and J. Yang, Journal of Power Sources, 2018, 393, 75-82, incorporated herein in its entirety. The two semicircles in the Nyquist plot for a mixed conductor represented the parallel combination of the electronic resistance and the geometrical capacitance at low frequencies; and that of the ionic resistance at high frequencies. Sintered at 580° C., the composite cathode showed a low ionic conductivity of 3.6×10⁻⁷ S cm⁻¹, due to the insufficient sintering (low mass density 2.96 g cm⁻³). Increasing the sintering temperature to 640° C. not only largely densified the pellet (mass density 3.13 g cm⁻³), but also improved the ionic and electronic conductivities to ˜1.9×10⁻⁵ S cm⁻¹ and 5.8×10⁻⁵ S cm⁻¹ (FIGS. 4C and 4D), respectively. The improved conductivity was attributed to the mixed conductive Li₃PO₄/Co₃O₄ interphases. Meanwhile, the interphase layer should also be thin enough to retain the active material and SSE amounts, so as to retain the high conductivity values. For example, the cathode sintered at 700° C. had the deteriorated ionic and electronic conductivities (˜6.3×10⁻⁶ S cm⁻¹ and ˜5.9×10⁻⁶ S cm⁻¹, respectively, FIGS. 4C and 4D, though it showed a higher mass density of 3.27 g cm⁻³. Interestingly, the LABTP/LCO-3:7 (mass density 3.43 g cm⁻³) showed the highest conductivity (FIG. 4B), and the calculated ionic and electronic conductivities were 7.0×10⁻⁵ S cm⁻¹ and ˜1.6×10⁻³ S cm⁻¹ (FIGS. 4C and 4D), respectively. Further increasing of the LCO content (LABTP/LCO-1:9), however, lowered the ionic and electronic conductivities to ˜8.0×10⁻⁶ S cm⁻¹ and ˜4.0×10⁻⁶ S cm⁻¹, respectively, shown in FIGS. 4C and 4D. This was because that there is no continuous interphase layer formed with only 10 wt. % of LABTP. It was noted that the excellent ionic and electronic conduction in the thick bulk electrode was due to the mixed conductive, ductile, and thin interphases facilitated by the liquid phase B₂O₃ additive. Otherwise, LATP reacted drastically with LCO to form thick, nonconductive reaction layer, exhibiting low ionic and electronic conductivities of 4.0×10⁻⁶ S cm⁻¹ and 5.0×10⁻⁷ S cm⁻¹ (FIGS. 4C and 4D), respectively.

Electrochemical Performance of SSBs Containing the LABTP/LCO Composite Cathodes

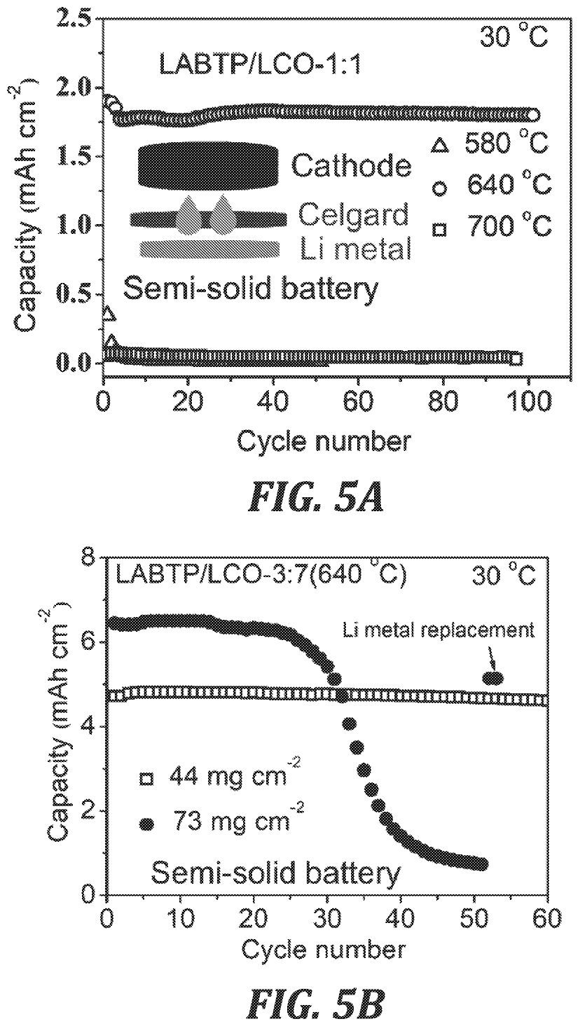

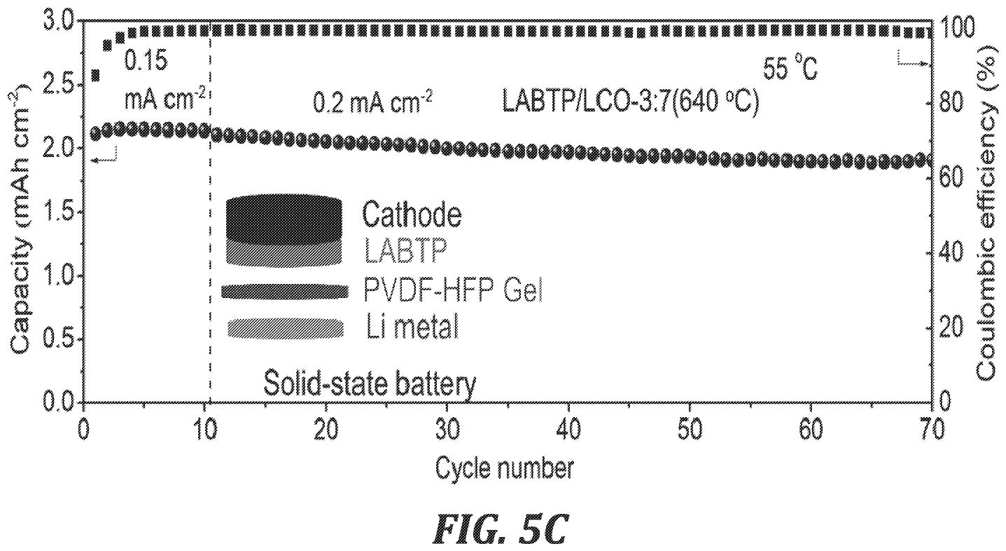

To evaluate the effects of mixed conductive interphases, the cycling performance of the LABTP/LCO-1:1 cathode in semi-solid cells was tested (FIG. 5A). The semi-solid cell was formed with the Li metal anode, the Celgard PP2500 separator with liquid electrolyte (1.2 M LiPF₆ in EC/EMC-3:7 with 2% VC), and the composite cathode. The cathode pellet thickness was around 210 μm and the active materials (LCO) loading was ˜33 mg cm⁻². The LABTP/LCO-1:1 (580° C.) cathode showed an initial discharge capacity of 11 mAh g⁻¹ with a Coulombic efficiency of ˜21% (3.0-4.2 V), caused by a significant voltage polarization, consistent with its porous structure and large resistance due to insufficient sintering and the lack of desired interphases. In contrast, the LABTP/LCO-1:1 (640° C.) cathode exhibited an initial discharge capacity of 57 mAh g⁻¹ (areal capacity 1.9 mAh cm⁻²) with a Coulombic efficiency of 96.4% (3.0-4.2 V). More importantly, this cell showed a stable cycling with ˜95% capacity retention after 100 cycles. The LABTP/LCO-1:1 (640° C.) cathode, tested in a wider voltage range of 3.0-4.4 V, gave a discharge specific capacity of 71 mAh g⁻¹ with an initial Coulombic efficiency of 95.8% and capacity retention ˜94% after 50 cycles. Sintered at higher temperatures, due to the drastic reactions between LABTP and LCO and thus enormous resistance, the discharge capacity diminished.

To increase the energy density, the LABTP/LCO-3:7 (640° C.) cathodes with thicknesses of 180 and 300 μm, corresponding to the active material loadings of 44 and 73 mg cm⁻², respectively, were also evaluated for 3.0-4.4 V. As shown in FIGS. 5B and 5C, the two cells show very high areal capacities of 4.7 and 6.5 mAh cm⁻², corresponding to specific capacities of 107 and 89 mAh g⁻¹, respectively. The former showed a rather stable cycling over 60 cycles. The latter exhibited a stable cycling for the first 30 cycles, followed by a rapid capacity fading. It is well known that Li metal was intrinsically unstable in carbonate electrolytes. At such a high current density (>0.5 mA cm⁻²), Li metal degraded very quickly to form thick solid electrolyte interphases (SEI) and dry up the electrolyte, hence the sudden cell failure. The Li anode of the ‘dead’ cell was replaced with fresh Li and refilled the cell with new liquid electrolyte, and the ‘refreshed’ cell recovered most of the capacity (˜5.1 mAh cm⁻²), corroborating the cell failure mechanism. Even at higher voltage, the composite cathode showed reasonable capacity retention. In addition, the mixed conductive interphases containing Li₃PO₄ may help to improve the cycling stability at high voltage. Furthermore, the unique network structure with ductile interphases can effectively accommodate the volume change of LCO during lithiation and delithiation. No crack was observed and the well-aligned interphase layer was still maintained after 50 cycles.

For solid-state batteries, a (PVDF-HFP) gel electrolyte was placed in-between the Li anode and the LABTP/LCO-LABTP to mitigate the severe Li/LATP reactions. The Nyquist plot contained three semicircles, corresponding to the ionic resistance (60.7 Ωcm²) of the gel and solid electrolytes at high frequencies, the interfacial resistance (248.4 Ωcm²) of various interfaces at the intermediate frequencies, and the total charge transfer resistance (733.9 Ωcm²) at low frequencies. The resistance values were about an order of magnitude lower that those reported for SSBs estimated based on the same mass loadings. The SSBs were tested at 55° C. (FIGS. 5B and 5C) between 3.0 and 4.4 V, which showed quite stable cycling for the initial 10 cycles at a current density of 0.15 mA cm⁻², and subsequently in order to expedite the testing processes, the current density was increased to 0.2 mA cm⁻² for the next 60 cycles. Overall, the solid cell delivered a high initial discharge capacity of 2.1 mAh cm⁻² and retained ˜90% capacity after 70 cycles. The cycling performance of the SSB of the present Example was comparable to those reported in the literature, but with almost 7-8 times higher areal capacity.

High Energy Density SSBs with the High-Ni NMC Cathode

To validate the feasibility of the interphase design for SSBs with even higher energy densities, the composite cathode was replaced with NMC622 (LiNi_{0.6}Mn_{0.2}Co_{0.2}O₂), which had high voltage, high specific capacity and intrinsically high values of electrical conductivity (˜10⁻³ S cm⁻¹). Due to the high electrical conductivity of NMC622, no LATP was needed in the cathode and 2 wt. % B₂O₃ was added to create the desirable interphases. A thin LATP SSE layer (˜350 nm) was sputtered on top of the cathode with 98 wt. % of NMC 622 (mass density 4.3 g cm⁻³). The B₂O₃ additive did not alter the overall electrical conductivity, and significantly improved the mechanical integrity of the sintered cathode. The existence of Li₃BO₃ interphase was confirmed by the XRD and EDS mapping. The grains displayed a compact morphology with intra-particle fractures, suggesting stronger inter-particle binding by Li₃BO₃; in contrast to the pure NMC622 cathode dominated by inter-particle fractures.

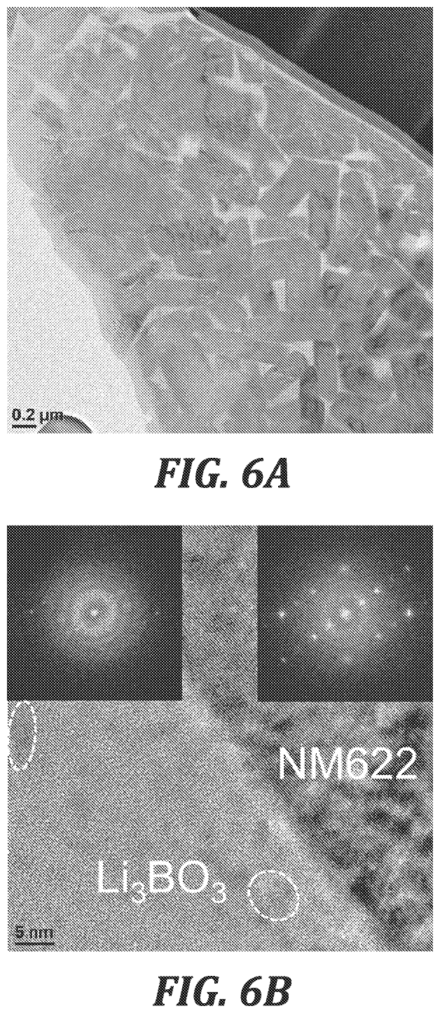

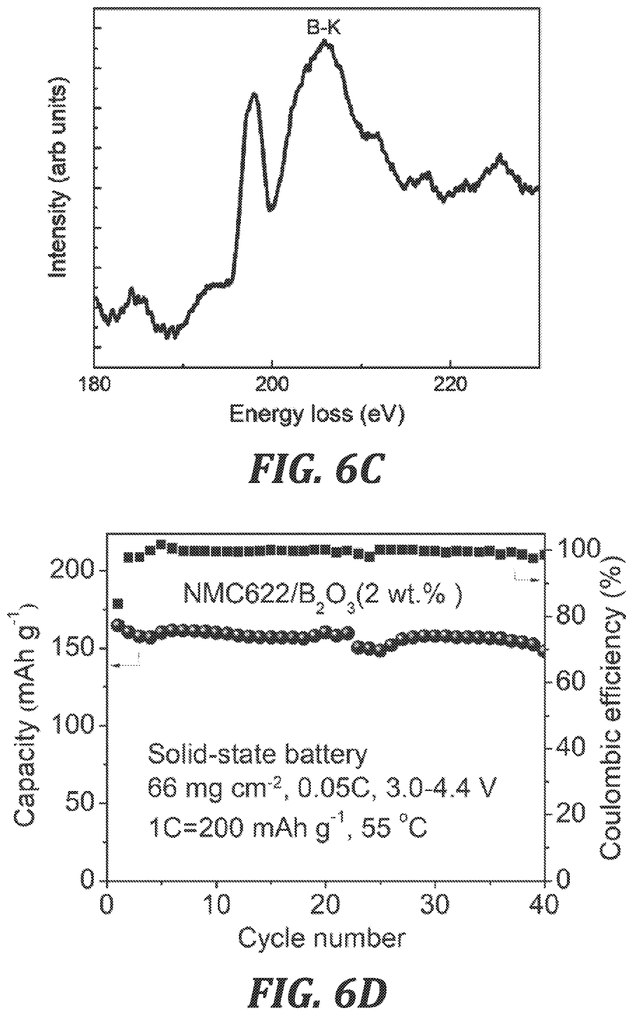

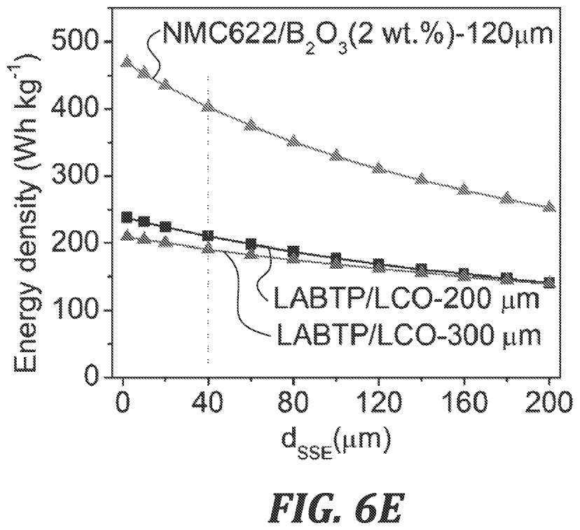

High resolution TEM and electron energy loss spectroscopy (EELS) were used to further analysis the interphase. As shown in FIG. 6A, the highly stacked NMC primary particles uniformly embedded in the Li₃BO₃ framework. FIG. 6B shows the dense and uniform interphase, which should facilitate fast Li⁺ transport. The grain boundaries were observed between NMC622 particles, and fast electron and Li⁺ transport were expected. The EELS data showed the distinctive K-edge of B in B₂O₃ (FIG. 6C) and those of the transition metals in NMC622. The electrochemical cycling performance of NMC622 cathode with 2 wt. % B₂O₃ was shown in FIG. 6D. The cathode thickness was 120 μm and the mass loading was 66 mg cm⁻². The SSB delivered an initial capacity of 165 mAh/g at a current density of 0.05 C (0.66 mA cm⁻²), with a capacity retention of 90% after 40 cycles at 55° C. Our cycling data compared favorably against the latest benchmark data published for SSBs, i.e., at 40 cycles a capacity retention of ˜63%, at a current density of 0.02 mA cm⁻² and at 100° C. The energy densities of SSBs using the LABTP/LCO and NMC622/B₂O₃ cathodes, LABTP SSE, PVDF/HFP (60 μm) and Li metal (50 μm) were calculated. As shown in FIG. 6E, the LABTP/LCO cathodes of >200 μm could reach an energy density above 200 Wh kg⁻¹ when the SSE thickness <40 μm. Due to its higher capacity, higher active material content, and higher mass density, the NMC622/B₂O₃ cathode could deliver a much higher energy density, >400 Wh kg′ was expected when the SSE thickness <40 μm.

In this Example, a low temperature sintering additive was used to improve the interfacial transport of electrons and Li⁺ between SSE LAPT and conventional cathode materials. The criteria for optimal sintering additives included low melting temperature, low surface energy at its liquid state, constituents and proper thermodynamics for forming mixed conductive interphases, strong mechanical binding to SSEs and the cathode active materials. The benefits of using B₂O₃ additive in making mechanical reliable cathodes with very superior kinetics and cycle stability in SSBs using NMC622 were demonstrated. Low temperature additives can be used in the making of high-energy and high mass density electrodes and SSBs.

While illustrative embodiments have been illustrated and described, it will be appreciated that various changes can be made therein without departing from the spirit and scope of the disclosure.

1. A lithium solid state battery, comprising:
a cathode comprising an active material comprising lithium; and
an additive having a lower melting point than the active material.

2. The lithium solid state battery of claim 1, wherein the active material comprises a lithium-containing layered oxide, a lithium-containing polyanion, a lithium-containing spinel, or any combination thereof.

3. The lithium solid state battery of claim 1, wherein the active material comprises a lithium-containing layered oxide (e.g., an NMC (LiNi_{1-x-y}MnₓCo_{y}O₂LiCoO₂), LiNi_{0.6}Mn_{0.2}Co_{0.2}O₂ (NMC622)).

4. The lithium solid state battery of claim 1, wherein the active material is in the form of particles having a dimension of from 100 nm to 90 μm.

5. The lithium solid state battery of claim 1, further comprising a solid electrolyte.

6. The lithium solid state battery of claim 5, wherein the solid electrolyte comprises Li_{1.3}Al_{0.3}Ti_{1.7}(PO₄)₃ (LATP).

7. The lithium solid state battery of claim 1, wherein the additive and the active material together form a eutectic mixture.

8. The lithium solid state battery of claim 5, wherein the additive, the active material, and the solid electrolyte together form a eutectic mixture.

9. The lithium solid state battery of claim 1, wherein the additive comprises B₂O₃, Bi₂O₃, and/or any other low melting temperature additive(s).

10. The lithium solid state battery of claim 1, wherein the additive is present in the cathode in an amount of 0.5% to 4% by weight (e.g., 0.5% to 2% by weight), relative to the mass of the total cathode.

11. The lithium solid state battery of claim 1, wherein the additive lowers a sintering temperature of the active material and the solid electrolyte, when present.

12. The lithium solid state battery of claim 11, wherein the additive lowers the sintering temperature of the active material and the solid electrolyte, when present, by 100° C. or more.

13. The lithium solid state battery of claim 1, wherein the additive has an interfacial energy of less than 1 J/m².

14. The lithium solid state battery of claim 1, wherein the additive has a melting point of ≤1000° C.

15. The lithium solid state battery of claim 1, wherein the additive is in the form of an interphase layer having a thickness of from 20 nm to 300 nm.

16. The lithium solid state battery of claim 15, wherein the interphase layer is between particles of active material and/or solid electrolyte, when present.

17. The lithium solid state battery of claim 1, further comprising a Li-metal anode and a gel electrolyte between the cathode and the anode.

18-44. (canceled)

45. A method of making a cathode for a lithium solid state battery, comprising:
mixing a lithium-containing cathode active material, an optional solid electrolyte, and an additive having a lower melting point than the active material to provide a mixture; and
sintering the mixture to provide the cathode.

46. The method of claim 45, wherein sintering comprises spark plasma sintering.

47-62. (canceled)

63. A method of making a lithium solid state battery, comprising:
providing a cathode made according to claim 45; and
assembling the cathode with a gel electrolyte and a lithium anode to provide the lithium solid state battery.
